(19) United States
(12) Patent Application Publication
(10) Pub. No.: US 2012/0256743 A1
(43) Pub. Date: Oct. 11, 2012

(54) LOCATION SYSTEM AND METHOD

(75) Inventors: Edwin T. Horton, Ballwin, MO (US); James N. Rothbarth, St. Louis, MO (US)

(73) Assignee: RF VISIBILITY LLC, St. Louis, MO (US)

(21) Appl. No.: 13/082,611

(22) Filed: Apr. 8, 2011

(51) Int. Cl. G08B 1/08

(52) U.S. Cl. 340/539.13

(57) ABSTRACT

An autonomous system of at least four transceivers located at fixed positions on a campus are networked to each other. Persons on the campus carries a fob or other transmitter. Each transceiver has a clock synchronized in time by a GPS satellite time signal. A location processor knows the fixed locations of the transceivers. When activated, each fob (of unknown location) transmits a unique alert signal. Each transceiver receives the alert signal. Based on time of receipt and known information, the location processor calculates a distance relative to each transceiver at which the fob is located to determine the location of the fob.

### FIELD OF THE INVENTION

The present invention generally relates to a system and method for use on a campus for locating the position of a person on the campus carrying a transmitter.

### BACKGROUND OF THE INVENTION

Security of a campus area may be a concern in certain environments, such as a university, corporate building complex or other campus. In the event of an emergency, it is helpful to know the location of individuals on the campus. In the past, individuals have been able to carry GPS receivers which have some capability of indicating the position of the individuals. However, such receivers can be inaccurate, have limited resolution and generally do not work effectively indoors or in heavy urban environments. Such receivers usually require an unrestricted or nearly unrestricted line of sight to GPS satellites. In addition, a GPS receiver alone does not inform anyone but the user of the user's position. When using GPS as part of a location system, the user's position must be transmitted to the system interested in tracking the user's location.

### SUMMARY OF THE INVENTION

In one form, the invention comprises an autonomous location system and method for use with a satellite transmitting a time information signal. A plurality of transmitters or transceivers (fobs) at unknown locations each selectively transmit a unique alert signal when activated. At least four transceivers connected by a network and positioned within an area have a fixed, known position in space. Each said transceiver has a local clock and is configured for receiving the alert signal and configured for receiving the time information signal used to synchronize its local clock. Each transceiver determines a time of receipt of the alert signal based on the local clock of the transceiver synchronized to the time information signal. A processor on the network determines the location of each of the transmitters (fobs) within the area. The processor is configured for receiving via the network the time of receipt of the alert signal by each transceiver and is configured to calculate the location of the transmitters within the area based on the received time of receipt of the alert signal by each transceiver and based on the fixed, known position of each transceiver.

In another form, the invention includes an autonomous system of at least four transceivers located at fixed positions on a campus are networked to each other. Persons on the campus carries a fob or other transmitter. Each transceiver has a clock synchronized in time by a GPS satellite time signal. A location processor knows the fixed locations of the transceivers. When activated, each fob (of unknown location) transmits a unique alert signal. Each transceiver receives the alert signal at a different time, depending on the distance of the fob from each transceiver. The location processor receives the time of receipt by each transceiver of the alert signal. Based on time of receipt and known information (the transceivers are at fixed distances and angles from each other), the location processor calculates a distance (the radius of a sphere) relative to each transceiver at which the fob is located. The intersection of the four spheres defines a unique three dimensional location corresponding to the location of the fob.

Other objects and features will be in part apparent and in part pointed out hereinafter.

### BRIEF DESCRIPTION OF THE DRAWINGS

FIG. 1 is a block diagram of one embodiment of a system of the invention having transceivers linking to a GPS satellite for synchronizing their clocks.

FIG. 2 is a block diagram of one embodiment of a system of the invention illustrating a fob or other transmitter/transceiver initially at an unknown location providing a location signal to the transceivers of the system.

FIG. 3 is a block diagram of one embodiment of a system of the invention illustrating the distances between each of the transceivers and a fob or other transmitter/transceiver initially at an unknown location.

FIG. 4 is a diagram of a two-dimensional scenario of three transceivers A, B, C located in a place and a fob or other transmitter/transceiver F initially at an unknown location within the plane, illustrating the distances and angles between each of the transceivers and a fob or other transmitter/transceiver.

FIG. 5 is a block diagram of one embodiment of a system of the invention illustrating transceiver #1 including a test transmitter sending a signal to the other transceivers used to compute a correction factor indicative of propagation errors within the space between the transceivers.

FIG. 6 is a block diagram of one embodiment of a local oscillator of a transceiver of the invention.

FIG. 7A is a perspective view of one embodiment of a fob housing of the invention having a flat, card-like configuration.

FIG. 7B is a block diagram of one embodiment of a fob transmitter/transceiver of the invention.

Corresponding reference characters indicate corresponding parts throughout the drawings.

### DESCRIPTION OF THE PREFERRED EMBODIMENTS

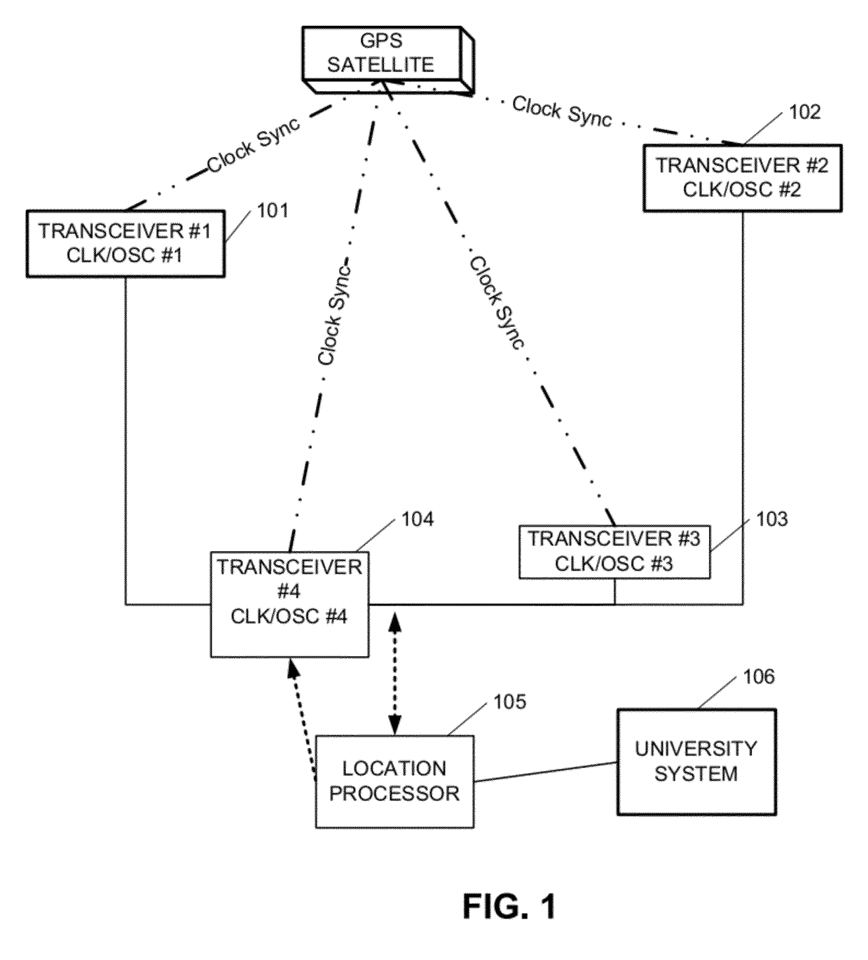

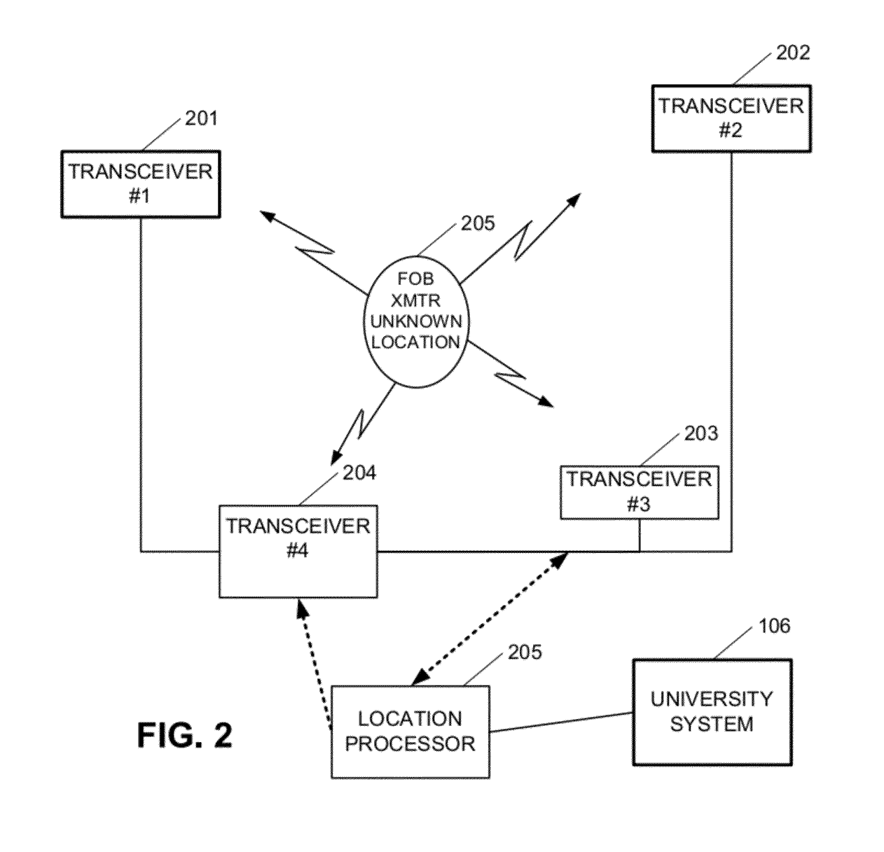

In general, the invention comprises a real-time location system (RTLS) which may be used in any environment to track any person or thing. For example, it may be used in a manufacturing environment to track products. It may be used in a construction or warehouse environment to track inventory. It may be used in a medical environment to track patients or their records or both. In one form, as illustrated in FIG. 1, the invention comprises location system for use with a satellite 100 transmitting a time information. A plurality of transmitters or transceivers (fobs, not shown in FIG. 1; see FIG. 2) are carried by a moveable object such as a user and/or a device in the area to be monitored.

Each fob is initially at an unknown location and when activated by its user transmits a unique alert signal. At least four transceivers 101-104 are connected via a network and positioned within the monitoring area. Each transceiver has a fixed, known position in space and each transceiver has a local clock synchronized to the time information from the satellite 100. When a transceiver receives the alert signal, it determines a time of receipt of the alert signal based on the local clock of the transceiver synchronized to the time information signal. A location processor 105 on the network determines the location of each of the transmitting fobs within the monitoring area. The processor is configured for receiving via the network the time of receipt of the alert signal by each transceiver. The processor calculates the location of the fobs within the area based on the received time of receipt of the alert signal by each transceiver and based on the fixed, known position of each transceiver. As shown by the dashed lines, the processor 105 may be separate and independent to the transceivers and connected to the network, or it may be separate and independent to the transceivers and connected to one of the transceivers, or it may be located within one of the transceivers, or it may be the processor of one of the transceivers.

In general, all transceivers may sync to same satellite. In this case, normal resolution would be about 12 nanoseconds (12 feet) but since transceivers are stationary, averaging and calibrating over time will provide better accuracy/resolution. The transceivers time sync to GPS and use the same Gold Key. They do not necessarily need to see the same satellite, although this may be an option.

Each transceiver gets its time codes from the GPS satellite and locks its oscillator to it. Over a period of time, e.g., several hours, the oscillator corrections make the oscillator very stable and reduce the mean quantization errors, increasing system accuracy.

Even if the satellite GPS signal is lost for a period of time, the local oscillator still provides accurate information for a period of time, depending on quality of oscillator.

### RF Visibility Transceiver Clock Generation and Synchronization

The RF Visibility location and tracking system and method of the invention (see FIG. 2) uses several spaced apart fixed transceivers 201-204 at known locations to capture time delays from a transmitter/transceiver (herein fob 205) initially having an unknown location to the remote transceivers 201-204. The location of transceivers 201-204 is known precisely in three-dimensional space. Since the distance is short and more or less assumed to be primarily straight-line (but not really “line of sight” because there is no direct visibility), the delay can be translated to distance, or pseudo-range. A location can be computed for the fob in question relative to the transceivers. The intent is to measure the primary distance between the fob and the transceivers by measuring the first arrival at each transceiver of the transmitted signal, and to avoid signal reflections. Since the transceivers are at fixed, known locations, the location of the fob can be determined once the primary distances are determined.

In one embodiment, the transceivers would be located on a campus area, preferably spaced from the perimeter. In general, transceivers are arranged so that the all four transceivers monitor all available areas from which there could be a fob transmission. The system of the invention provides a “campus wide” architecture, which does have a soft perimeter. Actual deployment will be based on a site survey to determine optimum transceiver placement given the physical constraints and coverage requirements. The fobs would be located by students on the campus area. The fobs would be activated by the students to indicate their position to the system. For example, the fob could be activated by a student in an emergency (or via a test switch) to let the system know the location of a student so that help could be sent to the student's location. Alternatively, although not discussed herein, it is contemplated that the fobs could be remotely activated by an activation signal to identify the location of one or more students in the campus area. Once activated, the fob would continue to transmit so that its position could be tracked. In one embodiment, the user cannot stop the fob from transmitting once it is activated. In one embodiment, the fob could transmit for a preset period of time and then it would automatically reset itself. In one embodiment, a query signal from one of the transceiver or other source could activate the fob and/or a signal from one of the transceivers or other source could deactivate fob transmission. For example, the fob may have a hall device or other sensor built into it, which would sense a particular signal having a particular format or identification. The police or other entity would have a transmitter which transmits the particular signal so that the police or other entity would be the only ones which have the ability to deactivate a fob that has been activated and is transmitting an alert signal. This would prevent a perpetrator from deactivating a fob.

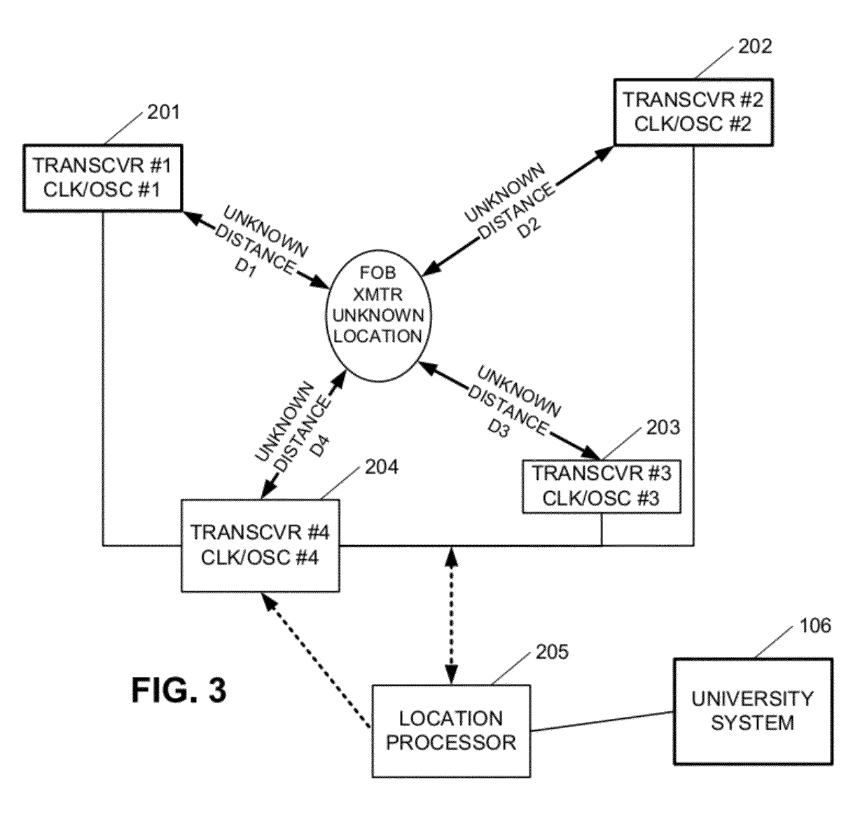

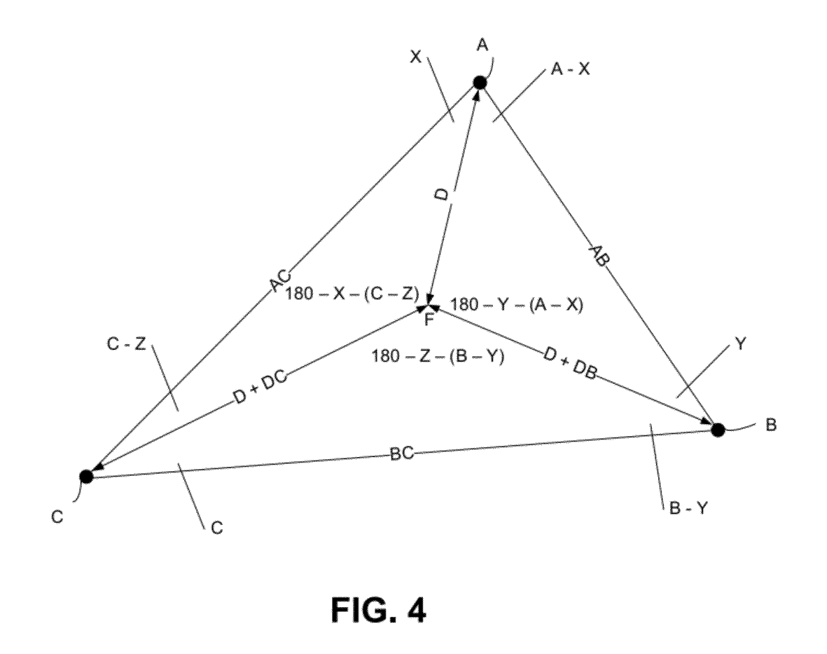

Since all of the transceivers used for the location solution hear the same transmitter/transceiver (fob), in order to provide a meaningful solution according to the invention, the transceivers are provided with a common time reference. So, a time delay can be measured that is of the form T(start-offset)+T(delay-distance) where T(start-offset) is the time offset that is the start of transmission of a fob at an unknown location relative to T(reference) in the transceiver and T(delay-distance) is the propagation time for the transmission to each the transceivers. T(reference) must be identical in time at each transceiver for these equations to provide useful accuracy to determine the unknown location of the transmitting fob. The common time reference insures that T(start-offset) is identical in all transceivers, thereby falling out of the position solution equations. See FIGS. 3 and 4.

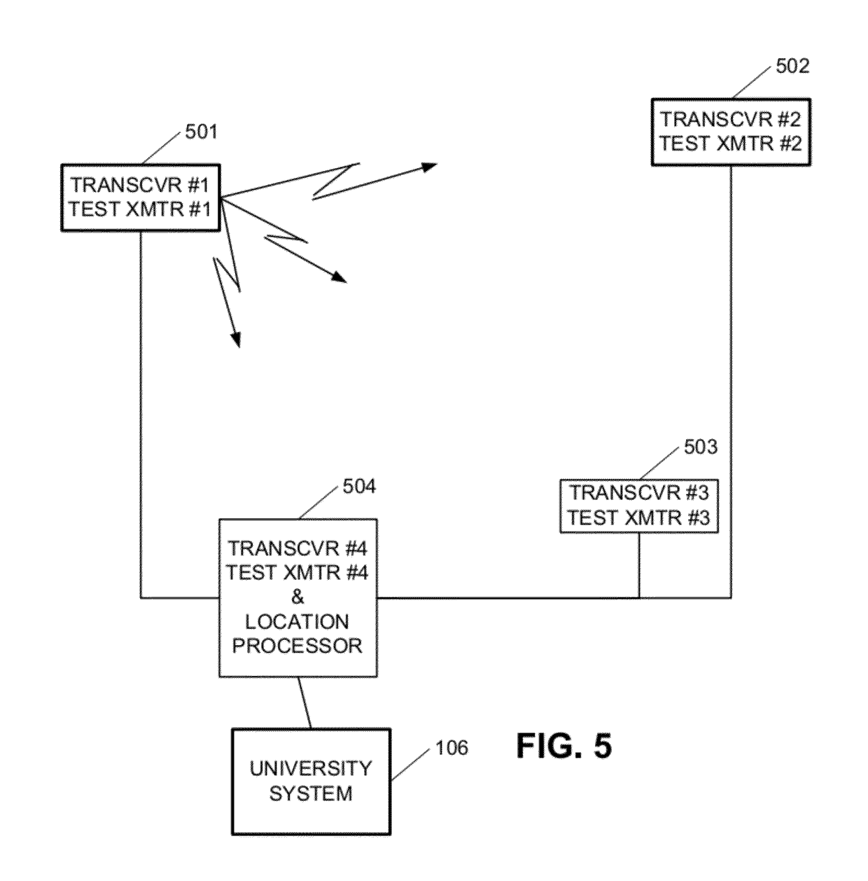

FIGS. 1-3 and 5 illustrate a location processor 105, 205. It could be co-located within a transceiver 504 as shown in FIG. 5, saving one network connection, or it would be an independent processor connected to the network or to a transceiver, as shown in FIGS. 1-3 by the dashed lines. If the location processor is co-located with a transceiver, it may be the processor of the transceiver or it may be a separate, independent processor.

One approach to achieve this is to have a single unit measuring all of the different time delays. However, in certain system configuration, this may be difficult to implement because the transceivers can be several thousand feet apart and the time delay to the processing unit must be characterized precisely.

Another approach is to provide a common time reference or time mark to each transceiver so that there is commonality across all transceivers and their time stamp of the received delay, which delay is based on the same time reference. This method simplifies the system architecture because transceivers can be deployed based on coverage alone with only minor regard to how the data is returned to the processing unit. One purpose of the GPS time mark is to assist in developing an internally generated Tidemark in the “long term”. As explained herein, from EPOC to EPOC, the system uses the internal Tidemark as the reference point.

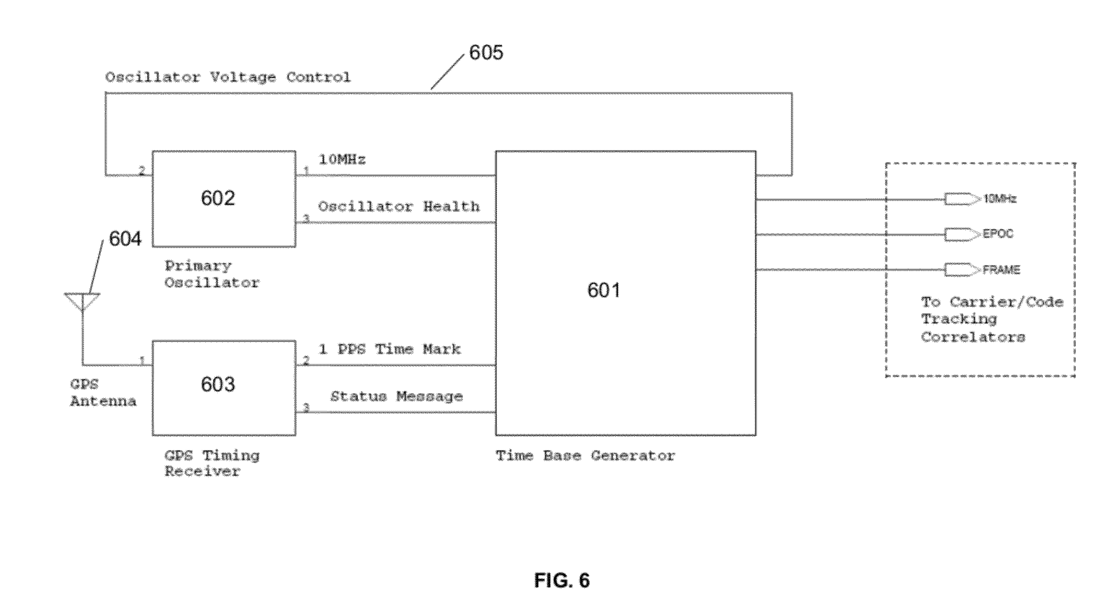

In one embodiment, the invention as shown in FIG. 1 combines a GPS satellite system 100 and highly stable reference oscillators 601 (see FIG. 6) in transceivers 101-104 to provide the timing needed. The GPS system provides satellite synchronization with on-board atomic clocks, manipulated as required from ground stations to drive errors to near zero. This allows simple GPS transceivers 101-104, when placed in a fixed location, to provide a time mark equal to the stability of the GPS system—in a longer term. This is an important consideration since GPS transceiver physical hardware constraints and non-perfect implementation due to jitter and quantization errors, allow the timing pulse to be non-precise in a random fashion in a shorter term.

As an example, all digital transceivers can only position the output reference time mark synchronous to their internal clock. If a transceiver uses a 200 MHz clock, which is found in most modern transceivers, this equates to 5 nsec of uncertainty alone. While these newer transceivers generate a message predicting the quantization error, this short-term signal alone produces about 5 feet of error. Jitter on the time mark due to finite rise and fall times of the signal itself, as well as circuit delay add additional errors.

However, over a long period of time (minutes not days), the average long term signal can approach near zero error due to the GPS satellite near perfect synchronization. Circuit delay can slightly reduce accuracy, but can be eliminated by periodic calibration, since it is not random and a function of circuit topology and implementation delays. Repeatable accuracy is more accurate than absolute instantaneous accuracy. Repeatable accuracy is better than absolute accuracy because repeatable accuracy reduces the effect of errors common to the system and its transmitting and receiving devices. In one embodiment, calibration is based on a combined signal, not individual transceivers.

According to aspects of the invention, the short term signal is coupled with the more accurate long term signal via a system clock that exhibits short term stability in order to “steer” the short term signal by the long term GPS reference signal and increase accuracy.

As shown in FIGS. 1 and 6, the system 100 uses an oversized quartz oscillator or low cost atomic oscillator such as a rubidium standard as a primary clock/oscillator 602 for each transceiver 101-104. The clock 601 of each transceiver is responsible for driving the entire transceiver circuitry. A GPS time mark is generated by a GPS timing transceiver 603 receiving a GPS signal including time information via a GPS antenna 604. The GPS time mark provided by synchronizing with the GPS satellite system, occurs once per second and is used to initially provide a T₀ reference point synchronized to the primary clock and additionally phase locked tracking for the long term. Initial primary clock error is a consideration since the GPS reference only happens every second and in one second a 10 MHz primary clock would have transitioned 10 million times. If cycle slip occurs, enough error exists in the primary clock so that 10 million±n cycles occurs. This could result in incorrect steering information being derived and/or synchronization will not occur quickly. In one embodiment, acquisition circuitry is added to prevent incorrect steering, by dividing the reference to a lower compare frequency, extending the compare time window to a time much longer than the error window. But this comparison only works for acquisition and once the frequency error is less that a cycle/second, then the tracking switches over to a final frequency phase compare for maximum accuracy, also aided by the quantization offset message.

Given all of this, one embodiment uses a good primary oscillator in each transceiver. At 10 MHz, 0.1 pap or a stability of 1*10⁻⁷ provides sufficient accuracy to prevent cycle slipping. As the oscillator is steered by the GPS transceivers, a stability of 1*10⁻¹² pap is achievable. In terms of feet, assuming 1 nsec delay is 1 foot, 1*10⁻¹² is 0.001 feet. Since all of the transceivers are corrected by the same GPS system, even this error is of little consequence to the system of the invention since absolute timing to a central reference is unimportant, just the relative timing between transceivers.

The primary clock used in the transceivers has an initial frequency accuracy of +15*10⁻¹¹. Aging is less than 5*10⁻¹¹/month. Aging over 10 years is less than 1*10⁻⁹. Again all of these numbers are for the primary oscillator uncorrected by the GPS time mark. There is a total adjustment range of ±1.5*10⁻⁹ giving a calibration cycle for this corrected primary oscillator of more than 10 years.

An added benefit of using a high quality primary oscillator such as this is that once locked, this oscillator can “coast” for hours with little segregation to timing accuracy should GPS signals be lost.

FIG. 4 illustrates three transceivers and the calculations to determine an unknown location of a fob in 3-D space. As long as the distances are known, the location can be determined. The system of the invention actually measures a pseudo-range, which is a delay from the Tidemark reference in each transceiver. All times are relative to the TIMEMark established by GPS, i.e., all delays have a T(offset) term added to them. This is purely a function of when the fob begins its transmission. To eliminate the time delays, a fourth transceiver is introduced to resolve this offset.

In one embodiment, each transceiver determines the time of receipt of the alert signal based only on the local clock of the transceiver synchronized to the time information signal so that each transceiver does not determine the time of receipt of the alert signal with reference to the time information signal. As a result, each transceiver uses the time information signal for the sole purpose of synchronizing its local clock and each transceiver is not adapted to use the time information signal to determine the time of receipt of the alert signal.

### Local Oscillator

FIG. 6 is a block diagram of one embodiment of a local oscillator of a transceiver of the invention. In one embodiment, the time base generator 601 comprises a field programmable gate array (FPGA), a microcontroller and a digital-to-analog (D/A) converter/amplifier. Its purpose is to take the 10 MHz signal from the primary oscillator 602, an a GPS derived 1PPS Time Mark signal and essentially lock the 10 MHz reference to the 1PPS signal. The primary oscillator is natively stable to about 1*10⁻⁹, but it also has a fine tune analog input that can allow tracking. The FPGA conditions the input 10 MHz signal and has a second order digital phase locked look (PLL) 605 forming a feedback loop with the D/A converter as the final interface to the oscillator.

In one embodiment, the FPGA incorporates two different loop bandwidths for optimum acquisition and tracking. Internally, a phase difference is measured between the 1PPS signal rising edge and the proper rising of the primary oscillator 602. An internal 500 MHz oscillator drives an UP/Down counter to quantize this error to 2 nSec. The resulting digital error word is used, along with an integrated and scaled version of the same, to generate the error signal to fine tune the oscillator 602. The loop is very narrow, on the order of 1 mHz, but given the nature of the design, the loop converges in a few minutes and the second order loop can drive the error to zero. Once tracking is achieved, the narrow bandwidth is sufficient given the total adjustment range of the primary oscillator 602.

The 1PPS signal may be generated by a U-Blox GPS module within each transceiver (or as part of the time base generator 601), optimized for timing applications. For example, it may be an LEA-6T module. The EPOC and FRAME signals are signals generated by the time base generator 601 representing the t₀, or starting point of the code clock. In one embodiment, the code length is 1000 bits long at a rate of 1 MB/s. As a result, the EPOC signal occurs 1 mSec or 100 time per 1PPS Time Mark. The Frame counter is the derived 1PPS signal. As noted above, timing is driven by the time base generator 601 and the primary oscillator 602. As a result, a 1PPS signal locked to the GPS clock is derived, but since there is a quantization error on the GPS time mark, it is more accurate (or more repeatable to be precise) to use the derived signal instead of the GPS clock.

In one embodiment, the FPGA is a Xilinx Spartan-6 series part, XC6SLX9-2TQG144C and the microcontroller is a Microchip PIC18F67J60 that controls the FPGA and the GPS module. It has an integrated TCP/IP Ethernet interface to provide real-time status via an internal Web Server. The D/A converter, LTC1657 may be a 16 Bit device, such as supplied by Linear Technology.

### FOB (Transmitter/Transceiver)

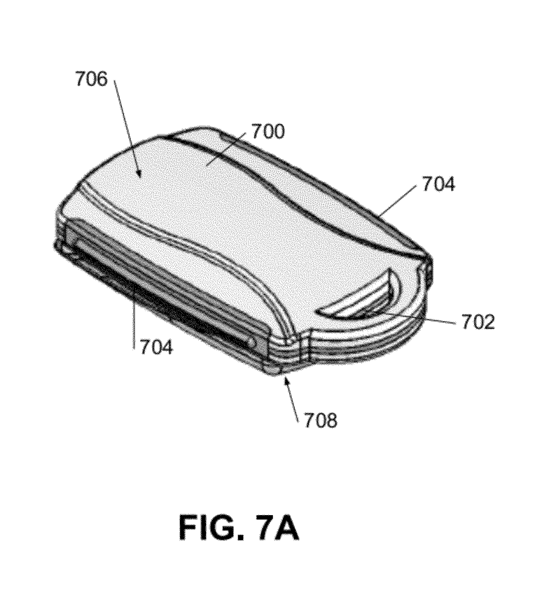

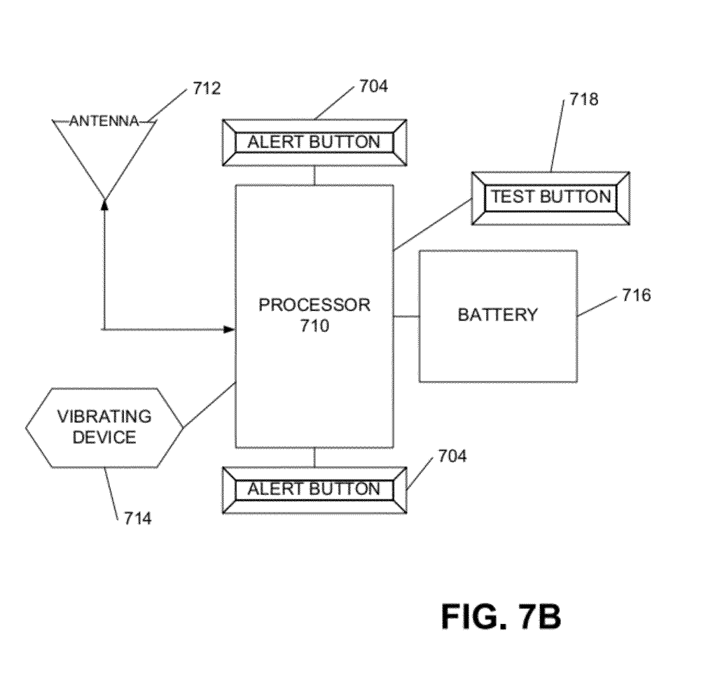

FIG. 7A is a perspective view of one embodiment of a fob having a flat, card-like housing 700 of the invention. In this embodiment, the fob (which may be a transmitter or a transceiver) includes an aperture 702 for engaging a key ring or other holder. Emergency buttons 704 are positioned on either side of the fob. Depending on the embodiment, one or both buttons may be pressed to energize the fob to transmit an alert signal. Traditional devices have detents or indexing buttons to activate a function located on the broad flat sides of the device. Traditional devices activate on only one side which may not be accessible in a pocket. These are not desirable features in an emergency.

A fob of the invention may be in a pocket or clipped to an under garment or hanging on a lanyard around the owner's neck. With only a moment to activate it, traditional devices take too much time. According to the fob of the invention, the entire sides of the fob are the activation button(s). All that needs to happen is a squeeze and the fob to activate it. A vibrator may be built in to provide feedback that the fob has been activated, although sound could also be used. A fob will lay on the body or in a pocket in one plane. It will lay on an edge which could cause a false activation. This would necessitate a configuration that can be activated on the horizontal sides. A fob could be a cylinder or round so that a squeeze is all that it takes to activate. In general, a fob should be capable of activation without indexing, without the need to look at the fob or without being limited to having activation available on one side only.

In one embodiment, the fob includes a dark colored planar surface 706 on one face and a light colored planar surface 708 on its opposing face. For example, one surface 706 may be white and the other surface 708 may be black. This configuration allows a user to decide how to wear the fob and what side and color to display. For example, the user may be carrying a dark colored case or dark colored purse. The user could attach the fob the case or purse so that the dark colored surface 708 is visible and blends with the case or purse. As another example, a user may be wearing light clothing and could attach the fob to their clothing so that the light colored surface 706 is visible and blends with the clothing.

FIG. 7B is a block diagram of one embodiment of a fob of the invention. A processor 710 generates a unique signal which is transmitted by an antenna 712 when one or both emergency buttons are pressed. An optional vibrating device 714 may be activated when the fob is energized to alert and confirm to the user that the fob has been energized. Alternatively or in addition, if the fob is a transceiver, the vibrating device 714 may be activated by one of the system transceivers #1-#4. A confirmation signal could be transmitted from one of the system transceivers #1-#4 to the fob to indicate to the owner of the fob that an alert signal has been transmitted and received. As noted above, the fob may be a transceiver in which case antennas 712 receives signals for demodulation by the fob's processor. The fob is energized by a battery 716, which may have a test switch 718 for providing a test signal, as noted herein. In another embodiment, the fob may be a transceiver for receiving information as well as transmitting information. In either configuration, the fob may have a programmable, variable duty cycle to conserve battery life.

Thus, in one form, the fob is a card that requires a student or user to push buttons on both sides of card to create an alert. The card permits pocket activation of the fob. Pocket activation is encouraged since in an emergency the user may not have the time or circumstance to take the fob out of a pocket or purse to activate. The fob having buttons on both sides is designed to minimize false alerts, and to eliminate the one sided index a button on the top or bottom usually has so that either top or bottom of the fob can lie flat in a pocket and not affect fob activation.

Alternatively, the fob may provide any type of tactile and/or audible feedback to the user that the fob has been activated.

### Optional Features of Autonomous Location System and Method

1. One or more of the transceivers may transmit a test signal to the other transceivers to calibrate time and to confirm that the system is operating properly. Since the transceivers are stationary and their distance from the transceiver sending the test transmitter is known and fixed, a correction factor can be computed to offset any propagation errors (one nanosecond error equates to approximately one foot error is position calculation). This includes both self-testing to determine a possible malfunction or error and calibration testing and correction to minimize inaccuracy and increase resolution. In one embodiment, each transceiver transmits a test signal and one transceiver is calibrated from the others at preset periods of time, such as every few minutes, e.g., 10 minutes. Multipath problems are minimized by the calibration achieved by the test signals.

2. The fob could have two types of buttons: a test button and an alert button or alert buttons. Using the test button, a test feature in key fob can be activated by a fob owner. The test feature when activated sends a test signal to the transceivers which cause an email, text or other message or display to be sent to the owner indicating the fob's location. The owner knowing their location can verify the accuracy of the test. In addition, the position indicated can be used to update and verify the system. If the test is not correct, the system can evaluate and/or recalibrate and/or adjust or alert an administrator.

3. In one mode, the fob is a transceiver sending a test signal and receiving a signal generated by the system indicating the fob's calculated position. Depending on whether the calculated position is correct, the fob owner would answer by sending a signal via the fob indicating not correct and updating the correct position or indicating correct. This may require a keypad or several buttons on the fob. This may also require specific owner information to be provided by the fob owner to eliminate false data being provided by a third party, e.g., the fob owner would provide a student ID or the password and user name which was entered by the fob owner at the time of fob registration in order to verify their identity.

4. Fobs may have a bar code on them. To register a fob to a student, the bar code and the student ID are scanned together. This results in the ID and the fob being connected or associated with each other. The system is connected to a University system 106 and has access to the student's personal information to connect the information to the fob. For example, medical and contact information on file with the University system could be associated with the fob. The fob could be a chip embedded in or on a student ID card. A student could register contact information with the system under the fob id that belongs to the student (e.g., information such as cell phone, parents, emergency contact information, doctor, medications). This information may be useful in the event of an emergency.

5. A delay time can be built into a fob to delay activation of the fob after the alert button is pushed. In this option, if the fob is activated inadvertently and starts to vibrate, the user can cancel the alert and/or cancel the vibration. This optional feature minimizes false alerts and saves battery power.

6. The fob could be waterproof and/or rechargeable, such as by an inductive charger or the fob may have a lifetime battery. In one embodiment, the fob may need to be rechargeable if the fob is a transceiver or otherwise a two-way communication device, depending on the amount of power need to both transmit and receive.

7. Firemen, policeman and security could have two-way fobs with continuous or intermittent transmitters or transceivers to provide real time position of each fob. Alternatively, the fob may be paired with a standard wireless phone, PDA or Ipad to provide a return path for communication over an existing commercial infrastructure.

8. A fob may also be linked to a smart device which has a GPS tracking feature to reduce system and calculation errors. Using a fob linked to a smart device can minimize or null system errors because the fob and the GPS tracking feature of the smart device would have substantially the same error, which would almost approach zero as the fob and smart device become closer to each other and are tracked over time. Thus, system errors and calculation errors could be minimized and/or effectively eliminated. Similarly, in the same way, two fobs may also be used to reduce system and calculation errors. Also, the system could compute the relative distance between a smart device and a fob (or between two fobs) to provide a graphical display on a laptop showing their relative positions so that errors can be reduced. If the actual distance between fobs is known, the actual distance can be used to correct the computed distance. In general, since two devices, one of which is a fob of the invention, would have the same errors, these errors can null out to improve accuracy significantly. In one form, a fob may be linked to a smart device via a USB or other port. In one embodiment, a first one of the transmitters is linked to a second one of the transmitters and there is a known distance between the transmitters. When both the first and second transmitters transmit a signal, the processor determines any common errors in the transmitted signals and uses the common error to reduce location calculations.

9. Transceivers could be connected to a pre-existing or dedicated network, as noted or illustrated above or the transceivers may use a WiFi hop to get connected to a network and each other and the location processor.

10. A unique identification number may be applied to the exterior housing of each fob by a police or security department so that the owner of a fob that is found could be determined by a cross reference between the unique id numbers and the names of the owners. The number may be a label on the housing or may be etched into the housing. Alternatively or in addition, a police or emergency telephone or text number can be applied to the exterior housing as a handy reference.

11. Fobs in combination with devices having specific monitoring functions can be added to the system. For example, at least one of the transmitters (fobs) is connected to a monitoring device for detecting an action. The monitoring device activates the one transmitter when the monitoring device detects the action. The fob would generate an alert signal when the associated device detects something. For example, a fob can be associated with a motion detector, a burglar alarm, or a panic button. When the motion detector detects motion, or burglar alarm is set off or a panic button is activated, the motion detector, burglar alarm or panic button could provide an activation signal to the fob causing the fob to activate and transmit an alert signal.

12. Lost and Found Feature—Lost and Found can be a defined area such as a police station. When a test signal is generated by a fob within the defined area, the transceivers cause a communication to be sent to the fob owner and police station. Thus, when a test or alert signal by the fob is generated within the defined boundary, the owner of the fob can be identified to the police and the owner can be alerted without initiating an emergency response. The test signal in the defined area will identify the owner of a lost fob to the police without triggering emergency action. System software can be programmed send the owner and police a message indicating that their fob has been found. In one embodiment, when the fob is a transceiver, a lost fob can be located by sending an activation signal to the fob which causes it to transmit so that it's location can be determined by the transceivers. For example, an area is designated as a lost-and-found area and a transmitter located in the designated lost-and-found area transmitting an alert signal does not initiate an emergency condition. Instead, the processor determines the owner of the transmitter and notifies the owner.

13. Ipad or Iphone Feature—when an fob initially having an unknown position (i.e., an unknown fob) is activated, Iphones, Ipads, laptops or smart phones carried by security can direct a security person to the location of the unknown fob via google maps. The transceivers would determine the location of the fob. The security person would carry an activated fob indicating their position. Since the position of the security person's activated fob relative to the determined position of the unknown fob could be determined once the unknown fob is activated, a display on a device carried by the security person (e.g., cell phone could be sent a text) could indicate the range and bearing of the unknown fob relative to the location of the security person. For example, the processor determines the position of an activated transmitter transmitting an alert signal, the processor determines or knows the position of a rescue person. As a result, the processor indicates to the rescue person the range and bearing of the activated transmitter relative to the position of the rescue person.

14. The fob may be a PSK transmitter/transceiver and/or a CDMA transmitter/transceiver. In general, the fob may transmit signals on multiple frequencies and/or signals with multiple modes. The fob can also make use of multiple frequency slots similar to GLONASS. To increase density, one embodiment transmits CDMA (code division multiple access) as well as FDMA (frequency division multiple access) modes.

15. Monitoring areas can be mapped when diagrams of the area are not available or to scale. In general, a fob at a known location is activated and the known location is added to a display to create a map of an area including the known location. For example, a fob carrier could activate a test signal from their fob. The test signal activates a google map showing their location. Then, the fob carrier can access the google map and add information to the map, such as room number, floor number, building name, etc. to help to create a more accurate map of the area.

16. A clip on the FOB may be used to secure it to clothing. It is important that the FOB is accessible 100% of the time. The clip provides an easy way to carry a fob when fashion may make carrying a safety device unfashionable or an embarrassment. Additionally, the clip may enable the fob to be carried without notice so that no one knows who is carrying a fob, leading to a strong deterrent.

17. Emergency information, such as a school's police department phone number or other emergency number could be applied to and/or molded into the housing of the fob. Other information could be applied/molded in. If there is an unintended alert, a phone number to cancel the alert may be molded into the housing so that it is readily available.

18. In some embodiments, the fob can have a power status indicator and/or a fob health indicator to indicate battery life or other transmission/reception aspects of the fob operation, such as transmitted or received signal strength.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of data and/or computer-executable instructions, such as program modules, stored one or more tangible computer storage media and executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computers and/or servers may execute the computer-executable instructions such as those illustrated herein to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules on a tangible computer readable storage medium. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A location system for use with a satellite transmitting a time information signal comprising:
A plurality of transmitters, each transmitter when activated transmitting an alert signal, each said transmitter initially within an area at an unknown location;
At least four transceivers connected by a network and positioned within or adjacent the area, each said transceiver in communication with the transmitters, each said transceiver having a fixed, known position in space, each said transceiver having a local clock, each said transceiver configured for receiving the alert signal and configured for receiving the time information signal used to synchronize its local clock, each said transceiver determining a time of receipt of the alert signal based on the local clock of the transceiver synchronized to the time information signal; and
A processor on the network for determining the location of each of the transmitters within the area, said processor configured for receiving via the network the time of receipt of the alert signal by each transceiver, said processor configured to calculate the location of the transmitters within the area based on the received time of receipt of the alert signal by each transceiver and based on the fixed, known position of each transceiver.

2. The system of claim 1 wherein the transmitter comprises at least one of a transceiver, a transmitter transmitting at least two signals having different modes and different frequencies, a PSK transmitter, a CDMA transmitter or a transmitter transmitting both PSK and CDMA signals.

3. The system of claim 1 wherein each transmitter comprises a transceiver adapted to be activated by a query signal provided by to the transceiver.

4. The system of claim 1 wherein each transceiver transmits a test signal to the other transceivers and wherein each of the other transceiver uses the test signal to compute a correction factor or a calibration factor indicative of propagation errors, said factor used by the processor to determine the location of the transmitters transmitting alert signals.

5. The system of claim 1 wherein each transmitter comprises a fob having two modes, a test mode which when manually activated sends a test signal to the transceivers and further comprising a processor sending an email, text or other message or display indicating the transmitter's calculated location whereby a person carrying the fob can verify the accuracy of the fob's location.

6. The system of claim 1 wherein each transmitter has a unique code and each transmitter is registered to a person by scanning a person's identification card and the code together so that the code and transmitter carrying the code are associated with the person of the scanned identification card.

7. The system of claim 6 wherein the system is connected to a personnel system and has access to the person's personal information and associates the information to the transmitter.

8. The system of claim 7 wherein the personal information comprises medical and contact information on file with the personnel system.

9. The system of claim 1 wherein the transmitters comprise a flat card-like housing having buttons on both sides of the card which when simultaneously activated cause the transmitter to transmit the alert signal.

10. The system of claim 1 wherein the transmitter comprises one or more of the following: a waterproof package, a battery which is inductively charged, a vibration device which may be activated to alert the person carrying the transmitter, a two way communication device, a clip on a housing of the transmitter to engage clothing, a power status indicator, a signal strength indicator, a battery life indicator, a transmission indicator and/or wherein the transmitter has a programmable, variable duty cycle.

11. The system of claim 1 wherein each transceiver includes a local clock providing a local time signal, said clock periodically synchronized to the time information signal from the satellite, said clock having an adjustable frequency, wherein the frequency of the clock is adjusted during each periodic synchronization to minimize any differences between the time information signal and the local time signal of the clock, and wherein each said transceiver determines a time of receipt of the alert signal based only on the local time signal.

12. The system of claim 11 wherein each said transceiver determines the time of receipt of the alert signal based only on the local clock of the transceiver synchronized to the time information signal so that each transceiver does not determine the time of receipt of the alert signal with reference to the time information signal, wherein each said transceiver uses the time information signal for the sole purpose of synchronizing its local clock and each said transceiver is not adapted to use the time information signal to determine the time of receipt of the alert signal.

13. The system of claim 1 wherein a unique identification number associated with its owner is applied to a housing of each fob so that the owner of a lost fob that is found could be determined by a cross reference between the its unique identification number and the associated name of the owner or wherein an emergency phone number is applied to a housing of each fob.

14. The system of claim 1 wherein the transmitter comprises a substantially flat, card-like housing having a dark colored planar surface on one face of the housing and having a light colored planar surface on an opposing face of the housing.

15. The system of claim 1 wherein the transmitter comprises a transceiver for transmitting the alert signal and for receiving a confirmation signal indicating that the alert signal has been received by one of the at least four transceivers.

16. The system of claim 1 wherein the transmitter comprises two types of buttons: a test button and an alert button or alert buttons wherein activating the test button activates a test feature which sends a test signal to the transceivers and wherein the transceivers, in response to receiving the test signal, cause an email, text or other message or display to be sent to the owner indicating the fob's location.

17. The system of claim 1 wherein the transmitter comprises a transceiver sending a test signal and receiving a signal generated by the system indicating the fob's calculated position and wherein, depending on whether the calculated position is correct, the fob owner send a signal via the fob indicating not correct or indicating correct.

18. The system of claim 1 wherein the transmitter, when activated, delays for a preset period of time the transmitting of an alert signal and wherein, during said preset period, the transmitter can be deactivated to cancel transmission of the alert signal whereby false alerts are minimized or wherein, during said preset period, vibration of the transmitter can be deactivated to reduce battery usage or wherein the transmitter has a sensor which senses a particular signal and the transmitter deactivates and discontinues transmitting an alert signal only when the sensor senses the particular signal.

19. The system of claim 1 wherein a first one of the transmitters is linked to a second one of the transmitters and there is a known distance between the transmitters and wherein, when both the first and second transmitters transmit a signal, the processor determines any common errors in the transmitted signals and uses the common error to reduce location calculations.

20. The system of claim 1 wherein the transceivers are connected to a pre-existing or dedicated network, or wherein the transceivers use a WiFi hop to connect to a network and to each other and to the location processor.

21. The system of claim 1 wherein one of the transmitters is connected to a monitoring device for detecting an action, said monitoring device activating the one transmitter when the monitoring device detects the action and wherein the monitoring device comprises one or more of a motion detector, a burglar alarm, or a panic button.

22. The system of claim 1 wherein an area is designated as a lost-and-found area and wherein a transmitter located in the designated lost-and-found area transmitting an alert signal does not initiate an emergency condition and wherein the processor determines the owner of the transmitter and notifies the owner.

23. The system of claim 1 wherein the processor determines the position of an activated transmitter transmitting an alert signal, wherein the processor determines or knows the position of a rescue person and wherein the processor indicates to the rescue person the range and bearing of the activated transmitter relative to the position of the rescue person.

24. The system of claim 1 wherein a transmitter at a known location is activated and the known location is added to a display to create a map of an area including the known location.

25. In a location system for use with:
A plurality of transmitters, each transmitter when activated transmitting an alert signal, each said transmitter initially within an area at an unknown location;
At least four transceivers connected by a network and positioned within or adjacent the area, each said transceiver in communication with the transmitters, each said transceiver having a fixed, known position in space, each said transceiver determining a position of a activated transmitter relative to each said transceiver, the improvement comprising:
each transmitter comprising a flat card-like housing having buttons on both sides of the card which when simultaneously activated cause the transmitter to transmit an alert signal.

26. The system of claim 25 wherein the transmitter comprises one or more of the following: a transceiver, a waterproof package, a battery which is inductively charged, a vibration device which may be activated to alert the person carrying the transmitter, a two way communication device, a clip on a housing of the transmitter to engage clothing, a power status indicator, a signal strength indicator, a battery life indicator, a transmission indicator and/or wherein the transmitter has a programmable, variable duty cycle.

27. The system of claim 25 wherein each transceiver includes a clock providing a local time signal, said clock periodically synchronized to the time information signal from the satellite, said clock having an adjustable frequency, wherein the frequency of the clock is adjusted during each periodic synchronization to minimize any differences between the time information signal and the local time signal of the clock, and wherein each said transceiver determines a time of receipt of the alert signal based only on the local time signal.

28. The system of claim 27 wherein each said transceiver determines the time of receipt of the alert signal based only on the local clock of the transceiver synchronized to the time information signal so that each transceiver does not determine the time of receipt of the alert signal with reference to the time information signal, wherein each said transceiver uses the time information signal for the sole purpose of synchronizing its local clock and each said transceiver is not adapted to use the time information signal to determine the time of receipt of the alert signal.

29. The system of claim 25 wherein the transmitter comprises at least one of a transceiver, a transmitter transmitting at least two signals having different modes and different frequencies, a PSK transmitter, a CDMA transmitter or a transmitter transmitting both PSK and CDMA signals.

30. The system of claim 25 wherein the transmitter comprises a substantially flat, card-like housing having a dark colored planar surface on one face of the housing and having a light colored planar surface on an opposing face of the housing.

31. The system of claim 25 wherein the transmitter comprises a transceiver for transmitting the alert signal and for receiving a confirmation signal indicating that the alert signal has been received by one of the at least four transceivers.

32. The system of claim 25 wherein the transmitters comprise a flat card-like housing having buttons on both sides of the card which when simultaneously activated cause the transmitter to transmit the alert signal.

33. The system of claim 25 wherein the transmitter has a sensor which senses a particular signal and wherein the transmitter deactivates and discontinues transmitting an alert signal only when the sensor senses the particular signal.
